(19) United States
(12) Patent Application Publication
(10) Pub. No.: US 2005/0253828 A1
(43) Pub. Date: Nov. 17, 2005

(54) Computer system and method of controlling the same

(75) Inventor: Jong-min Jeong, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 11/082,790

(22) Filed: Mar. 18, 2005

(30) Foreign Application Priority Data
May 12, 2004 (KR) 2004-33613

(51) Int. Cl. G09G 5/00

(52) U.S. Cl. 345/204

(57) ABSTRACT

A computer system having an internal graphics module; an external graphics module detachably connected to the computer system; and a power controller turning on/off power supplied to the internal graphics module depending on a connection state of the external graphics module. With this configuration, the computer system and the method of controlling the system prevent wasteful power consumption.

### CROSS-REFERENCE TO RELATED APPLICATION

This application claims the benefit of Korean Patent Application No. 2004-33613, filed on May 12, 2004 in the Korean Intellectual Property Office, the disclosure of which is incorporated herein by reference.

### BACKGROUND OF THE INVENTION

1. Field of the Invention

The present invention relates to a computer system and a method of controlling the same, and more particularly, to a computer system and a method of controlling the computer system to prevent wasteful power consumption by cutting off power unnecessarily supplied when an external graphics module is connected to the system.

2. Description of the Related Art

In general, a computer system performs graphic functions through an internal graphics module such as an internal graphics card electrically connected to a motherboard.

Also, recently, a GMCH (Graphics Memory Controller Hub) chipset, which includes a MCH (Memory Controller Hub) chipset with a graphics module or a controller, is installed on the motherboard performing graphic functions without being connected to an internal graphics card. Herein, the graphics module is supplied with separate driving power from other modules of the GMCH chipset.

If the GMCH chipset is installed on the motherboard, the GMCH chipset provides an interface through which the external graphics module is detachably installed. Thus, when the internal graphics card is employed instead of the graphics controller of the GMCH chipset, if the external graphic module is connected to an external port (for example, an AGP port and a PCI port, etc.) as necessary, the external graphics module performs the graphic function.

However, although the conventional computer system employs the detachable external graphics module instead of an internal graphics module, power is still supplied to both, the external graphics module and the internal graphics module, resulting in wasteful power consumption of the power. Moreover, the inactivated internal graphics module continuously outputs a video signal.

### SUMMARY OF THE INVENTION

According to an aspect of the present invention, there is provided a computer system and a method of controlling the computer system preventing wasteful power consumption.

According to another aspect of the present invention, there is provided a computer system comprising an internal graphics module; an external graphics module detachably connected to the computer system; and a power controller turning on/off power supplied to the internal graphics module depending on a connection state of the external graphics module.

According to another aspect of the present invention, the power controller comprises a switch turning on/off the power supplied to the internal graphics module; and a detector detecting the connection state of the external graphics module, and turning on/off the switch depending on the connection state of the external graphics module.

According to another aspect of the present invention, the detector comprises a first resistor outputting an uninstallation detecting signal to the switch if the external graphics module is not connected to the computer system; and a second resistor outputting an installation detecting signal to the switch if the external graphics module is connected to the computer system, and the switch is turned on if the first resistor outputs the uninstallation detecting signal and turned off if the second resistor outputs the installation detecting signal.

According to another aspect of the present invention, the first resistor comprises one of a pull-up resistor and a pull-down resistor respectively outputting a pull-up state signal and a pull-down state signal as the uninstallation detecting signal, and the second resistor comprises the other one of the pull-up resistor and the pull-down resistor respectively outputting the pull-up state signal and the pull-down state signal as the installation detecting signal.

According to another aspect of the present invention, the detector comprises a resistor generating an installation detecting signal if the external graphics module is connected; and a microcomputer turning off the switch to cut off the power applied to the internal graphics module according to the installation detecting signal generated from the resistor.

According to another aspect of the present invention, the resistor comprises either a pull-up resistor or a pull-down resistor respectively outputting a pull-up state signal and a pull-down state signal as the installation detecting signal.

According to another aspect of the present invention, the computer system further comprises a given interface for communication between the detector and the external graphics module, wherein the detector communicates with the external graphics module through the interface, and turns off the switch if detected through the communication that the external graphics module is connected.

According to another aspect of the present invention, the detector comprises a communicator communicating with the external graphics module through the interface; and one of a BIOS, a microcomputer and a firmware hub turning off the switch if detected through the communication of the communicator that the external graphics module is connected.

According to another aspect of the present invention, the interface comprises either an I²C bus or an SM bus, and the communicator comprises either a GMCH (graphic memory controller hub) communicating with the external graphics module through the I²C bus, or an ICH (I/O controller hub) communicating with the external graphics module through the SM bus.

According to another aspect of the present invention, the external graphics module comprises a graphics chipset having a GPIO (General Purpose Input/Output) pin, and the detector comprises an activator activating the GPIO pin if the external graphics module is connected to the computer system; and a BIOS checking a state of the GPIO pin when the computer system is booted and the graphics chipset is initialized, and turning off the switch if the GPIO pin is activated.

According to another aspect of the present invention, the activator comprises a resistor receiving power of the system and outputting an activating signal, when the activator is connected to the computer system.

According to another aspect of the present invention, the resistor comprises a pull-up resistor outputting a pull-up state signal as the activating signal.

According to another aspect of the present invention, there is provided a method of controlling a computer system comprising detecting whether or not an external graphics module is connected to a computer system; and turning on/off power supplied to an internal graphics module depending on a connection state of the external graphics module.

According to another aspect of the present invention, the method comprising turning off power supplied to the internal graphics module if determined that the external graphics module is connected to the computer system.

According to another aspect of the present invention, there is provided a portable computer system comprising a controller detecting whether an external graphics module is connected to the portable computer system, and cutting off a driving power supplied to an internal graphics module if detected that the external graphics module is connected to the portable computer system.

According to another aspect of the present invention, the controller comprises a pull-up resistor and a pull-down resistor generating a switch control signal turning on a switch if the external graphics module is not connected to the portable computer system, and turning off the switch if the external graphics module is connected to the portable computer system.

According to another aspect of the present invention, the controller comprises an installation detecting signal generator generating an installation detecting signal if the external graphics module is connected to the portable computer system; and a microcomputer turning off a switch corresponding to the installation detecting signal.

According to another aspect of the present invention, the installation detecting signal generator comprises a pull-down resistor outputting a pull-down state signal if the external graphics module is connected to the portable computer system.

According to another aspect of the present invention, the controller comprises a microcomputer and/or a BIOS turning off a switch if the internal graphics module detects that the external graphics module is connected to the portable computer system.

According to another aspect of the present invention, the external graphics module comprises a graphics chipset comprising a GPIO (General Purpose Input/Output) pin; an activator connected to the GPIO pin and activating the GPIO pin if the external graphics module is connected to the portable computer system; and a BIOS checking a state of the GPIO pin when the portable computer system is booted and the graphics chipset is initialized, and turning off a switch if the GPIO pin is activated.

According to another aspect of the present invention, the activator comprises a pull-up resistor.

According to another aspect of the present invention, the switch is a transistor.

According to another aspect of the present invention, the external graphics module comprises a graphics chipset comprising a GPIO (General Purpose Input/Output) pin; an activator connected to the GPIO pin and activating the GPIO pin if the external graphics module is connected to the portable computer system; and a FirmWare Hub (FWH) checking a state of the GPIO pin when the portable computer system is booted and the graphics chipset is initialized, and turning off the switch if the GPIO pin is activated.

According to another aspect of the present invention, the external graphics module comprises a graphics chipset comprising a GPIO (General Purpose Input/Output) pin; an activator connected to the GPIO pin and activating the GPIO pin if the external graphics module is connected to the portable computer system; and a FirmWare Hub (FWH) checking a state of the GPIO pin when the portable computer system is booted and the graphics chipset is initialized, and turning off the switch if the GPIO pin is activated.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of a computer system;

FIG. 2 is a control block diagram of the computer system according to a first embodiment of the present invention;

FIG. 3 is a control block diagram of the computer system according to a second embodiment of the present invention;

FIG. 4 is a control block diagram of the computer system according to a third embodiment of the present invention;

FIG. 5 is a control block diagram of the computer system according to a fourth embodiment of the present invention; and

FIG. 6 is a control flow of the computer system according to another embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

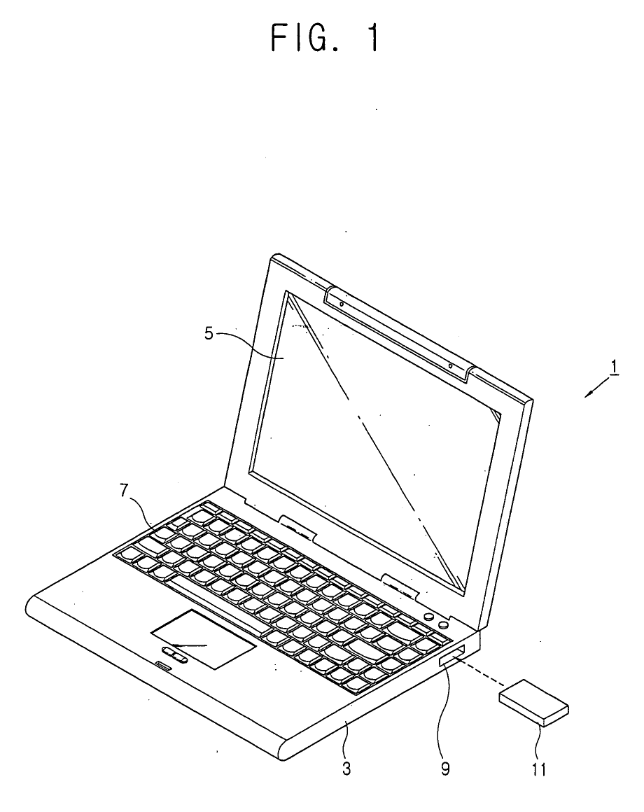

FIG. 1 is a perspective view of a computer system according to an embodiment of the present invention. As shown therein, a computer system 1 includes a main body 3 to which a motherboard (not shown) is connected and processing various kinds of data; a display 5 coupled to the main body 3 and displaying an image thereon; and a keyboard 7 integrally provided on the main body 3 and generating a key input signal corresponding to a user's operation.

Further, the main body 3 includes a slot 9 and a connecter through which an external graphics module 11 is detachably connected. The external graphics module 11 installed through the slot 9 is connected to the motherboard to perform a graphic function.

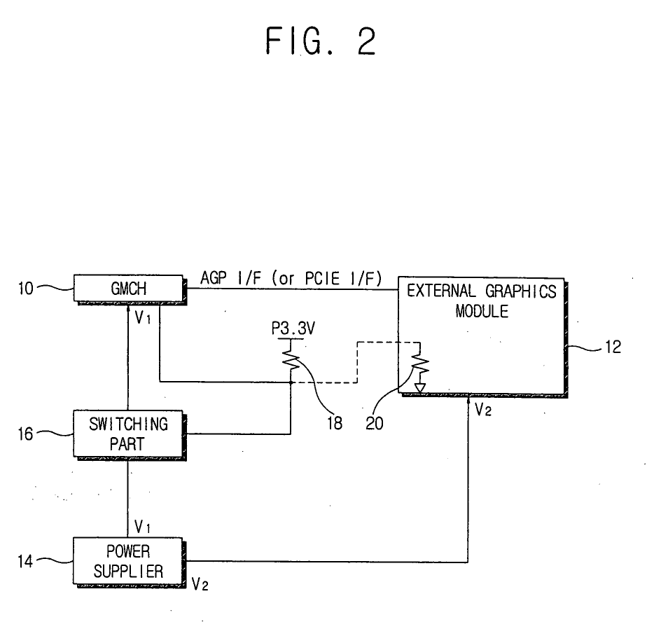

External graphics modules 12, 32, 52 and 72 in FIGS. 2 to 5 are connected to the motherboard through an interface provided by a GMCH (Graphics Memory Controller Hub) chipset according to various embodiments of the present invention.

FIG. 2 is a control block diagram of the computer system according to a first embodiment of the present invention. As shown therein, the computer system includes a GMCH chipset 10 managing data traveling between a CPU (Central Process Unit), a main memory and an internal graphics module; an external graphics module 12 detachably connected to the computer system through a given interface (for example, an AGP (Accelerated Graphics Port) interface and a PCIE interface) provided by the GMCH chipset 10; a power supplier 14 respectively supplying driving power V1 and V2 to an internal graphics module (not shown) of the GMCH chipset 10 and to the external graphics module 12; a switch 16 turning on/off the driving power supplied to the internal graphics module of the GMCH chipset 10; a pull-up resistor 18 connected to the switch 16; and a pull-down resistor 20 connected to the external graphics module 12.

The switch 16 is preferably but not necessarily a transistor turned on/off depending on the gate input voltage. The switch 16 according to several of the embodiments of the present invention acts as a transistor turning on when a high signal is inputted to a gate terminal, and turning off when a low signal is inputted to the gate terminal.

If the external graphics module 12 is not connected to the computer system, the pull-up resistor 18 connected to the switch 16 generates the high signal and applies the high signal to the gate terminal of the switch 16. Thus, the switch 16 is turned on and the computer system performs the graphic function using the internal graphics module of the GMCH chipset 10.

Meanwhile, if the external graphics module 12 is connected to the computer system, the pull-down resistor 20 of the external graphics module 12 is connected to the switch 16 to generate the low signal and applies the low signal to the gate terminal of the switch 16. Thus, the switch 16 is turned off and the driving power V1 supplied to the internal graphics module of the GMCH chipset 10 by the power supplier 14 is cut off.

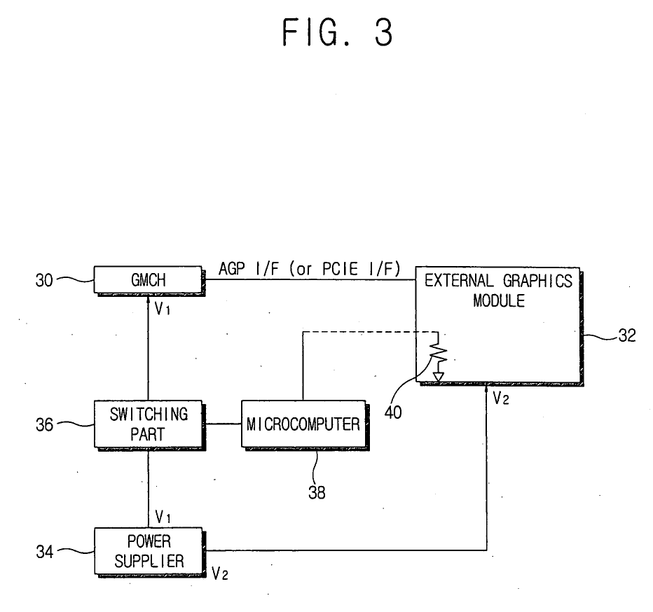

FIG. 3 is a control block diagram of a computer system according to a second embodiment of the present invention. As shown therein, the computer system includes a GMCH chipset 30 managing data traveling between a CPU (Central Process Unit), a main memory and an internal graphics module; an external graphics module 32 detachably connected to the computer system through a given interface provided by the GMCH chipset 30; a power supplier 34 respectively supplying driving power to an internal graphics module (not shown) of the GMCH chipset 30 and to the external graphics module 32; a switch 36 turning on/off the driving power supplied to the internal graphics module of the GMCH chipset 30 from the power supplier 34; a pull-down resistor 40 in the external graphics module 32; and a microcomputer 38 controlling the switch 36 depending on a connection state of the external graphics module 32.

If the external graphics module 32 is connected to the computer system, the pull-down resistor 40 generates a low signal notifying that the external graphics module 32 is connected to the computer system, and transmits the low signal to the microcomputer 38. The microcomputer 38 receives the low signal, perceives that the external graphics modules 32 is connected, and turns off the switch 36 to cut off the driving power supplied to the internal graphics module of the GMCH chipset 30.

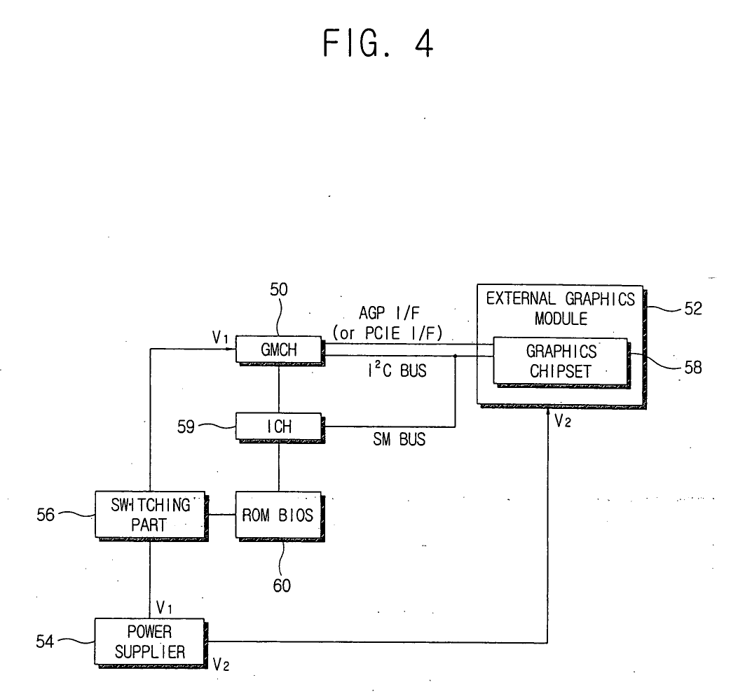

FIG. 4 is a control block diagram of a computer according to a third embodiment of the present invention. As shown therein, the computer system includes a GMCH chipset 50; an external graphics module 52 detachably connected to the computer system through a given interface provided by the GMCH chipset 50; a power supplier 54 respectively supplying driving power to an internal graphics module of the GMCH chipset 50 and to the external graphics module 52; a switch 56 turning on/off the driving power supplied to the internal graphics module of the GMCH chipset 50 from the power supplier 54; an ICH (I/O Controller Hub) 59 managing an input and output of a peripheral device; and a ROM BIOS 60 storing a BIOS.

Here, the GMCH chipset 50 or the internal graphics module of the GMCH chipset 50 communicates with a graphics chipset 58 of the external graphics module 52 through an I²C bus so that the BIOS can perceive that the external graphics module 52 is connected to the computer system. Further, the GMCH chipset 50 may communicate with a graphics chipset 58 of the external graphics module 52 through an SM bus to perceive whether the external graphics module 52 is connected.

If the BIOS senses that the external graphics module 52 is installed through the GMCH chipset 50 or the ICH 59, the BIOS turns off the switch 56 to cut off the driving power supplied to the internal graphics module of the GMCH chipset 50.

Herein, a microcomputer or a FWH (FirmWare Hub) communicating with the ICH 59 through an LPC interface may substitute for the BIOS.

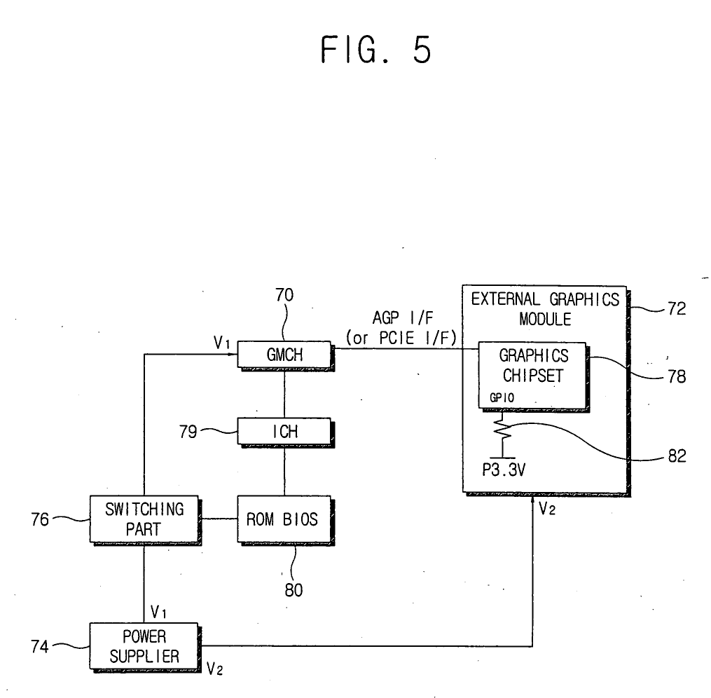

FIG. 5 is a control block diagram of a computer system according to a fourth embodiment of the present invention. As shown therein, the computer system includes a GMCH chipset 70; an external graphics module 72 detachably connected to the computer system through a given graphics interface provided by the GMCH chipset 70; a power supplier 74 respectively supplying power to an internal graphics module of the GMCH chipset 70 and to the external graphical module 72; a switch 76 turning on/off the power supplied to the internal graphics module of the GMCH chipset 70 by the power supplier 74; an ICH 79 managing an input and output of a peripheral device; a ROM BIOS 80 storing a BIOS; and a pull-up resistor 82 connected to a GPIO (General Purpose Input/Output) pin of a graphics chipset 78 in the external graphical module 72.

Herein, the external graphics module 72 receives the power from the power supplier 74 of the computer system, and accordingly the driving power supplier 74 supplies a voltage of P3.3V to the pull-up resistor 82. Thus, the GPIO pin of the graphics chipset 78 is in a pull-up state when the external graphics module 72 is connected to the computer system.

When the system is booted, a video BIOS stored in the ROM BOIS 80 checks a state of the GPIO pin when the graphics chipset 78 of the external graphics module 72 is initialized. Herein, if the GPIO pin is in a pull-up state, the BIOS senses that the external graphics module 72 is connected to the system and turns off the switch 76. Accordingly, the power supplier 74 cuts off the power supplied to the internal graphics module of the GMCH chipset 70. Herein, a microcomputer or an FWH may substitute for the BIOS.

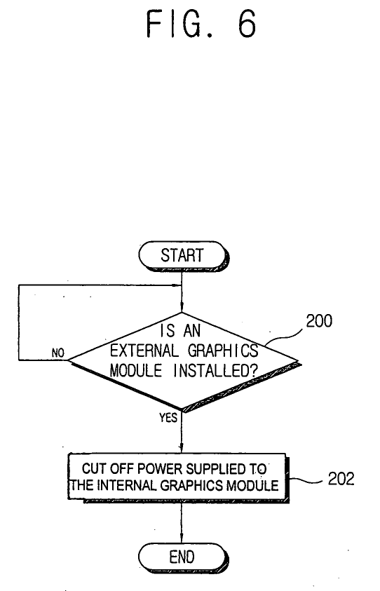

FIG. 6 illustrates a control flow of the computer system according to at least several of the embodiments of the present invention.

At first, the computer system detects whether the external graphics module 11, 12, 32, 52 and 72 is installed or connected at operation S200. As a result, the driving power supplied to the internal graphics module is cut off if the external graphics module 11, 12, 32, 52 and 72 is connected to the system, at operation S202.

Although the foregoing embodiments of the present invention describe a notebook computer as an example of the computer system, the computer system of the present invention may include computers such as a laptop computer, and a palmtop computer, etc.

According to the above embodiments of the present invention, the driving power supplied to the internal graphics module of the GMCH chipset is cut off when the external graphics module is connected to the computer system. However, if the computer system uses an internal graphics card without the GMCH, the driving power supplied to the internal graphics card is cut off when the external graphics module is connected to the computer system.

Meanwhile, the pull-up resistor and the pull-down resistor respectively turn on and off the switch according to the first embodiment of the present invention, but if the transistor which is turned on by the low signal and turned off by the high signal is applied as the switch, it also may be turned on and off by the pull-down resistor and the pull-up resistor.

The fourth embodiment senses whether the external graphics module is connected to the computer system depending on the pull-down resistor, but the fourth embodiment may also sense whether the external graphics module is connected to the system depending on the pull-up resistor.

Accordingly, the computer system of the present invention prevents wasteful power consumption by cutting off the driving power supplied to the internal graphics module when the external graphics module is installed to the computer system, and accordingly the internal graphics module does not generates a needless video signal.

Although a few embodiments of the present invention have been shown and described, it would be appreciated by those skilled in the art that changes may be made in these embodiments without departing from the principles and spirit of the invention, the scope of which is defined in the claims and their equivalents.

1. A computer system, the computer system comprising:
an internal graphics module;
an external graphics module detachably connected to the computer system; and
a power controller turning on/off power supplied to the internal graphics module depending on a connection state of the external graphics module.

2. The computer system according to claim 1, wherein the power controller comprises a switch turning on/off the power supplied to the internal graphics module; and a detector detecting the connection state of the external graphics module, and turning on/off the switch depending on the connection state of the external graphics module.

3. The computer system according to claim 2, wherein the detector comprises a first resistor outputting an uninstallation detecting signal to the switch if the external graphics module is not connected to the computer system; and a second resistor outputting an installation detecting signal to the switch if the external graphics module is connected to the computer system, and the switch is turned on if the first resistor outputs the uninstallation detecting signal and turned off if the second resistor outputs the installation detecting signal.

4. The computer system according to claim 3, wherein the first resistor comprises one of a pull-up resistor and a pull-down resistor respectively outputting a pull-up state signal and a pull-down state signal as the uninstallation detecting signal, and the second resistor comprises the other one of the pull-up resistor and the pull-down resistor respectively outputting the pull-up state signal and the pull-down state signal as the installation detecting signal.

5. The computer system according to claim 2, wherein the detector comprises a resistor generating an installation detecting signal if the external graphics module is connected; and a microcomputer turning off the switch to cut off the power applied to the internal graphics module according to the installation detecting signal generated from the resistor.

6. The computer system according to claim 5, wherein the resistor comprises either a pull-up resistor or a pull-down resistor respectively outputting a pull-up state signal and a pull-down state signal as the installation detecting signal.

7. The computer system according to claim 2, further comprising:
a given interface for communication between the detector and the external graphics module, wherein
the detector communicates with the external graphics module through the interface, and turns off the switch if detected through the communication that the external graphics module is connected.

8. The computer system according to claim 7, wherein the detector comprises a communicator communicating with the external graphics module through the interface; and one of a BIOS, a microcomputer and a firmware hub turning off the switch if detected through the communication of the communicator that the external graphics module is connected.

9. The computer system according to claim 8, wherein the interface comprises either an I²C bus or an SM bus, and the communicator comprises either a GMCH (graphic memory controller hub) communicating with the external graphics module through the I²C bus, or an ICH (I/O controller hub) communicating with the external graphics module through the SM bus.

10. The computer system according to claim 2, wherein the external graphics module comprises a graphics chipset having a GPIO (General Purpose Input/Output) pin, and the detector comprises an activator activating the GPIO pin if the external graphics module is connected to the computer system; and a BIOS checking a state of the GPIO pin when the computer system is booted and the graphics chipset is initialized, and turning off the switch if the GPIO pin is activated.

11. The computer system according to claim 10, wherein the activator comprises a resistor receiving power of the system and outputting an activating signal when the activator is connected to the computer system.

12. The computer system according to claim 11, wherein the resistor comprises a pull-up resistor outputting a pull-up state signal as the activating signal.

13. A method of controlling a computer system, the method comprising:
detecting whether or not an external graphics module is connected to a computer system; and
turning on/off power supplied to an internal graphics module depending on a connection state of the external graphics module.

14. The method of controlling the computer system according to claim 13, the method comprising:
turning off power supplied to the internal graphics module if determined that the external graphics module is connected to the computer system.

15. A portable computer system comprising:
a controller detecting whether an external graphics module is connected to the portable computer system, and cutting off a driving power supplied to an internal graphics module if detected that the external graphics module is connected to the portable computer system.

16. The portable computer system according to claim 15, wherein the controller comprises:
a pull-up resistor and a pull-down resistor generating a switch control signal turning on a switch if the external graphics module is not connected to the portable computer system, and turning off the switch if the external graphics module is connected to the portable computer system.

17. The portable computer system according to claim 15, wherein the controller comprises:
an installation detecting signal generator generating an installation detecting signal if the external graphics module is connected to the portable computer system; and
a microcomputer turning off a switch corresponding to the installation detecting signal.

18. The portable computer system according to claim 17, wherein the installation detecting signal generator comprises:
a pull-down resistor outputting a pull-down state signal if the external graphics module is connected to the portable computer system.

19. The portable computer system according to claim 15, wherein the controller comprises:
a microcomputer and/or a BIOS turning off a switch if the internal graphics module detects that the external graphics module is connected to the portable computer system.

20. The portable computer system according to claim 15, wherein the external graphics module comprises:
a graphics chipset comprising a GPIO (General Purpose Input/Output) pin;
an activator connected to the GPIO pin and activating the GPIO pin if the external graphics module is connected to the portable computer system; and
a BIOS checking a state of the GPIO pin when the portable computer system is booted and the graphics chipset is initialized, and turning off a switch if the GPIO pin is activated.

21. The portable computer system according to claim 20, wherein the activator comprises a pull-up resistor.

22. The portable computer system according to claim 16, wherein the switch is a transistor.

23. The portable computer system according to claim 15, wherein the external graphics module comprises:
a graphics chipset comprising a GPIO (General Purpose Input/Output) pin;
an activator connected to the GPIO pin and activating the GPIO pin if the external graphics module is connected to the portable computer system; and
a FirmWare Hub (FWH) checking a state of the GPIO pin when the portable computer system is booted and the graphics chipset is initialized, and turning off the switch if the GPIO pin is activated.

24. The portable computer system according to claim 1, wherein the external graphics module comprises:
a graphics chipset comprising a GPIO (General Purpose Input/Output) pin;
an activator connected to the GPIO pin and activating the GPIO pin if the external graphics module is connected to the portable computer system; and
a FirmWare Hub (FWH) checking a state of the GPIO pin when the portable computer system is booted and the graphics chipset is initialized, and turning off the switch if the GPIO pin is activated.
